(19) United States
(12) Patent Application Publication
(10) Pub. No.: US 2006/0168291 A1
(43) Pub. Date: Jul. 27, 2006

(54) Interactive multichannel data distribution system

(76) Inventors: Alexander van Zoest, San Diego, CA (US); Aaron Robinson, San Diego, CA (US); Roland Osborne, Walnut Creek, CA (US); Brian Fudge, San Diego, CA (US); Kevin Fry, Poway, CA (US); Mayur Srinivasan, San Diego, CA (US); Jason Braness, San Diego, CA (US); William McDonald, Mission Viejo, CA (US)

Correspondence Address: CHRISTIE, PARKER & HALE, LLP, PO BOX 7068, PASADENA, CA, 91109-7068, US

(21) Appl. No.: 11/198,142

(22) Filed: Aug. 4, 2005

Related U.S. Application Data
(60) Provisional application No. 60/642,065, filed on Jan. 5, 2005.
(60) Provisional application No. 60/642,265, filed on Jan. 5, 2005.

(51) Int. Cl. G06F 15/16

(52) U.S. Cl. 709/231

(57) ABSTRACT

Multimedia distribution systems are disclosed in which servers communicate with clients via audio, video, overlay and/or control channels. Information sent between the clients and servers on the audio, video and/or overlay channels includes timestamps. The timestamps coordinate the queuing and processing of information received by the client. Once information has been processed by the client, the client can report information concerning the timestamps associated with the processed information to the server. In one embodiment, the invention includes a server connected to a client via a network. In addition, at least one server is configured to communicate audio, video, overlay and control information with a client via separate audio, video, overlay and control channels, information transmitted on at least one of the audio, video and overlay channels includes time stamps, the client is configured to process the audio, video and overlay information for output to one or more rendering devices and the client is configured to transmit information concerning time stamps of processed information to the server via the control channel.

### CROSS-REFERENCE TO RELATED APPLICATIONS

This application claims the benefit of U.S. Provisional Patent Application No. 60/642,065, filed Jan. 5, 2005, and U.S. Provisional Patent Application No. 60/642,265, filed Jan. 5, 2005, the contents of which are hereby expressly incorporated by reference in their entirety.

### FIELD OF THE INVENTION

The present invention relates generally to multimedia distribution and more specifically to interactive multimedia distribution systems.

### BACKGROUND

Audio and/or video information can be provided in a variety of forms to consumer electronics devices, which can then display the information. A consumer electronics device that requires media in a fixed form such as a compact disk (CD) or digital video disk (DVD) is limited to playing the CDs or DVDs available to the user. In order to increase the amount of audio and/or video information accessible to a user at any given time, manufacturers of consumer electronics have sought to transfer audio and/or video information contained on fixed media to a storage device within the consumer electronics device. Systems that use internal storage provide added convenience, but typically limit the user to displaying the audio and/or video information contained on the storage device. Another approach to making more audio and/or video information available to users has been to provide the consumer electronics device with network connectivity. When a consumer electronics device is connected to a network, the audio and/or video information can be stored remotely and provided as desired to the consumer electronics device via the network. In many instances, consumer electronics devices are provided with the ability to extract audio and/or video information from fixed media, store audio and/or video information and obtain audio and/or video information via a network.

### SUMMARY OF THE INVENTION

Embodiments of the present invention distribute multimedia over a network. One embodiment of the invention includes a server connected to a client via a network. In addition, at least one server is configured to communicate audio, video, overlay and control information with a client via separate audio, video, overlay and control channels, information transmitted on at least one of the audio, video and overlay channels includes time stamps, the client is configured to process the audio, video and overlay information for output to one or more rendering devices and the client is configured to transmit information concerning time stamps of processed information to the server via the control channel.

In a further embodiment, the client is further configured to place audio, video and overlay information into audio, video and overlay queues. In another embodiment the client is further configured to process received control information by resynchronizing with a server. In a still further embodiment, the client is further configured to forward one of a set of predetermined user instructions to the server and the server is further configured to send information via at least one of the audio, video, overlay and control channels in response to the forwarded user instruction.

In yet another embodiment, the server is further configured to select information to send to the client in response to the forwarded user instruction based upon information maintained by the server concerning information that has been processed by the client. In a still further embodiment again, the information maintained by the server includes time stamp information received from the client. In a still further embodiment the information sent by the server includes an instruction sent on the control channel directing the client to reinitialize at least one of the audio, video and overlay channels.

In still yet another embodiment, the client is further configured to process received audio, video and overlay information by placing information in one or more queues and the information sent by the server includes an instruction sent on the control channel that directs the client to flush at least one of the one or more queues.

In a still further additional embodiment the instruction directs the client to flush all of the one or more queues. In still yet another additional embodiment, the server includes a first server configured to communicate audio information to the client using the audio channel and a second server configured to communicate video information to the client using the video channel. In a yet still further embodiment, the server includes a first server configured to communicate audio information to the client using the audio channel and a second server configured to communicate overlay information to the client using the overlay channel.

In another further embodiment, the server includes a first server configured to communicate video information to the client using the video channel and a second server configured to communicate overlay information to the client using the overlay channel.

In yet another further embodiment, the server includes a first server configured to provide information to a client via at least one of the audio, video and overlay channels and a second server configured to provide information to the client via at least one of the audio, video and overlay channels in response to an instruction received from the first server via the control channel. In still another further embodiment, the server comprises a first server and a second server, the client is configured to receive a user instruction and forward the user instruction to the first server and the first server is configured to respond to the user instruction forwarded by the client by providing an instruction to the second server directing it to provide information to the client.

In another further embodiment again the client is configured to process information received on the audio, video and overlay channels as soon as the information is received by the client.

In still yet another further embodiment, the client includes an internal timer set by the server, the client is further configured to process information received on the audio, video and overlay channels for output on one or more rendering devices when a time stamp associated with the information matches the internal timer.

In still yet another further embodiment again the client includes an internal timer synchronized to the server, the client is further configured to process information received on the audio, video and overlay channels for output on a rendering device when a time stamp associated with the information is less than or equal to the client's internal timer.

In another further additional embodiment, the client is further configured to synchronize the processing of audio information received on the audio channel with video information received on the video channel.

Still another further additional embodiment includes a processor and a network interface configured to communicate with the processor and to receive packets of audio, video, overlay and control information on separate channels. In addition, the processor is configured to place information from the packets of audio, video and overlay information in audio, video and overlay queues, inspect queued audio, video and overlay information for time stamps and select information in the audio, video and overlay queues for processing based upon the time stamps of the information. Furthermore, the processor and network interface are also configured to transmit a report containing information concerning the time stamp of at least one of the packets selected for processing. Many embodiments can also include a user interface, where the processor is further configured to generate a control message for output on the network interface in response to predetermined input from the user interface. In several embodiments, the network interface is configured to forward control messages received on a control channel to the processor. In addition, the processor can be further configured to respond to a predetermined control message by flushing the audio, video and overlay queues. Another aspect of embodiments of the present invention is that the audio, video and overlay queues can be initialized in a first configuration and the processor can be further configured to reinitialize the audio, video and overlay queues to a second configuration in response to a predetermined control message.

Yet another further additional embodiment includes a processor and a network interface in communication with the processor. In addition, the processor and network interface are configured to transmit audio, video, overlay and control information including time stamps and the network interface is further configured to receive control information. In many embodiments, the processor is configured to select audio, video and overlay information to transmit in response to the received control information. In several embodiments, the processor is further configured to select control information to transmit in response to the received control information. In another aspect of one embodiment of the invention, the processor can be further configured to store information concerning the display of audio, video and overlay information by a client from a received control message. In a further aspect of many embodiments of the invention, the processor can be further configured to select audio, video and overlay information to transmit in response to the received control information based upon stored information concerning the display of audio, video and overlay information by a client.

An embodiment of the method of the invention includes transmitting audio, video, overlay and control information and time stamps associated with one or more of the audio, video, overlay and control information, receiving the audio, video, overlay and control information and the time stamps associated with one or more of the audio, video, overlay and control information, queuing the received information in separate audio, video and overlay queues, processing the queued information based on the time stamps associated with the information, transmitting a reporting indicating at least one time stamp of the processed information, receiving the report and recording information concerning the at least one time stamp contained within the received report. A further embodiment of the method invention also includes responding to received control information.

An additional embodiment of the method of the invention includes responding to the received control information by flushing the audio, video and overlay queues. Another further embodiment of the method of the invention also includes receiving a user instruction and transmitting information indicative of the user instruction. In a further additional embodiment of the method of the invention, the processing includes rendering audio, video and overlay information.

### BRIEF DESCRIPTION OF THE DRAWINGS

FIG. 1 is a schematic view of an embodiment of a distribution system in accordance with the present invention;

FIG. 2 is a schematic view of a server connected to a client in accordance with an embodiment of the present invention showing the communication channels between the server and the client;

FIG. 3 is a schematic circuit diagram of a server in accordance with an embodiment of the present invention;

FIG. 4 is a schematic circuit diagram of a networked consumer electronics device that is a client in accordance with an embodiment of the present invention;

FIG. 5 is a flow chart showing the operation of a client in accordance with an embodiment of the present invention during the initialization and conduct of a session;

FIG. 6 is a flow chart showing the operation of a server in accordance with an embodiment of the present invention during the initialization and conduct of a session;

FIG. 7 is a flow chart showing the manner in which a client in accordance with an embodiment of the present invention handles incoming packets of media information;

FIG. 8 is a flow chart showing the operation of a client in accordance with an embodiment of the present invention in response to the receipt of a user instruction from a user and control instructions from a server;

FIG. 9 is a flow chart showing the operation of a server in accordance with an embodiment of the present invention in response to the forwarding of a user instruction by a client; and

FIG. 10 is a schematic view of an embodiment of a distribution system in accordance with the present invention.

### DETAILED DESCRIPTION OF THE INVENTION

Turning now to the drawings, embodiments of the present invention include at least one server connected to at least one client via a network and enable the distribution of audio and/or video information. In one aspect of many embodiments, the server can transmit a variety of information to a client. Each type of information is typically transmitted on a separate channel. In another aspect of many embodiments, the server selects information to send to the client in response to user instructions forwarded to the server by the client on a control channel. In many embodiments, the servers can create the impression to the user that they are navigating through an interactive graphical user interface by providing an appropriate sequence of audio, video and/or overlay information to a client for display in response to a user's instructions. In order to achieve interactivity, the server typically maintains information concerning the state of the user interface being displayed by the client. In addition, the server can control the configuration of a client to reduce latency when transitioning from one user interface state to another in response to a user input.

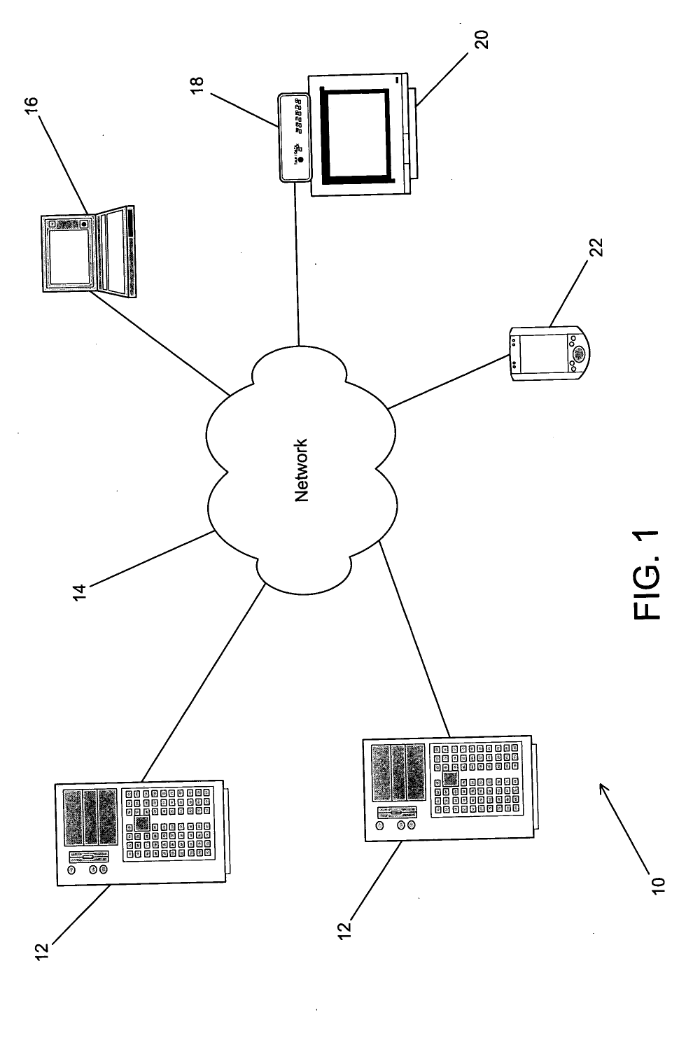

An embodiment of a distribution system in accordance with the present invention is illustrated in FIG. 1. The distribution system 10 includes a number of servers 12 connected to a number of devices via a network 14. In the illustrated embodiment, the devices include a computer 16, a set top box 18 connected to a television 20 and a hand held computing device 22. Each of the devices includes software and/or hardware that enable them to act as a client for the purposes of interacting with the servers 12 and, therefore, the term client is used throughout to describe any device capable of communicating with a server in accordance with an embodiment of the present invention.

Although some clients possess extremely sophisticated computational abilities, many other clients have limited computational and storage capabilities. Therefore, clients in accordance with the present invention typically execute a very simple routine that does not vary directly in response to most user instructions. The bulk of the processing is shifted to the servers, which handle user input and implement the system's interactive functionality. The servers can control the information displayed by the clients in a very precise manner, which enables the servers to respond to users' requests by ensuring that the required information is displayed by the client almost immediately. Typically, the clients do not possess the capability to interpret the majority of user requests. The clients simply forward user requests to the server and display information provided to them by the server in the manner directed by the server. The operation of the server, network and clients is discussed below.

The servers 12, network 14 and clients are configured to enable the servers to transmit information to clients via the network. In one embodiment, the server and the clients communicate over a fixed network using the TCP/IP protocol. In other embodiments, other network communication protocols can be used and fixed connections can be replaced with wireless connections. The term network is used throughout to refer to any connectivity between a server and a client including a direct connection, a home network, a local area network, a wide area network, a private network and networks of networks such as the Internet.

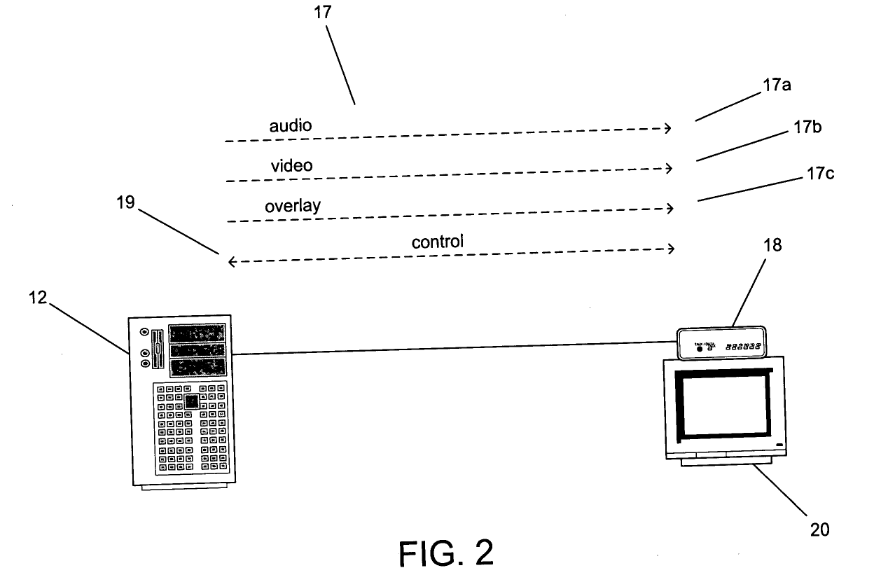

The communication channels established between a server and a client in accordance with an embodiment of the present invention are conceptually illustrated in FIG. 2. A server 12 in accordance with an embodiment of the present invention can establish separate communication channels 17 with a client for audio, video and overlay information. In addition, a control channel 19 can be established enabling two way communication of control information between the server and the client.

The video channel 17b is used to communicate packetized video information from the server to the client. As will be discussed in greater detail below, the video channel is configured in accordance with the nature of video contained within the packets of video information. The packets of video information typically contain encoded frames of video. The frames may be part of a feature presentation or part of a menu or user interface. The term “feature presentation” is used throughout to describe a continuous video sequence such as a feature length film that typically plays linearly and does not require user interaction. The term “feature presentation” is meant in a broad sense and is not limited to feature length films, encompassing all types of prerecorded video and broadcast video streams.

The audio channel 17a is used to communicate packetized audio information. As with the video channel, the server specifies the characteristics of the audio channel. The audio data transmitted by the audio channel does not necessarily accompany video or overlay information. Many embodiments of the present invention offer the capability of distributing sound recordings (e.g., music). The audio information can also accompany video information transmitted on the video channel. In many instances the audio information is the sound track accompanying a “feature presentation”. However, the audio information can also be a sound effect forming part of a menu or user interface.

The overlay channel 17c is a channel that can be used by the server to transmit overlay information to the client. Overlays are graphics or text that can be superimposed on frames of video. Examples of overlays include subtitles accompanying a “feature presentation” or a highlighted menu option that is part of a menu or user interface. Overlay information can be encoded graphically or as text. In one embodiment, overlays are encoded in accordance with the jpeg file interchange format specified by the Joint Photographic Experts Group. In another embodiment, overlays are encoded as bit maps. The nature of the overlay information and of the overlay channel itself is usually specified by the server.

The control channel 19 is a channel that can be used by both the server and the client to transmit control information. Embodiments of systems in accordance with the present invention typically function more effectively when the control channel is configured to reliably communicate information between the server and the client. As will be discussed in greater detail below, the client can use the control channel to request a control session with a server and to forward user instructions and timing information to the server. In turn, the server can use the control channel to establish the audio, video and overlay channels with the client and to provide instructions to the client concerning the manner in which it should display received audio, video and overlay information. The ability of the server and client to communicate over the control channel enables the overall system to interact with users. For example, a client in accordance with an embodiment of the present invention can use the control channel to forward user commands to the server. The server can then respond to the user commands by sending information to the client via the audio, video, overlay and/or control channels. Appropriate selection of the audio, video, overlay and/or control information can achieve such effects as an interactive menu or fast forwarding, pausing or rewinding of a feature presentation. The manner in which interactive features can be implemented in accordance with aspects of embodiments of the present invention is discussed further below.

In many embodiments of the present invention, communication over the network 14 is conducted in accordance with the TCP/IP protocol. In embodiments. where the TCP/IP protocol is used, separate channels can be established by assigning a separate port address to each of the channels. In this way, packets of information can be sent across the network and a port address can be used to determine with which channel the packet is associated. In other embodiments, the UDP protocol is used in conjunction with the IP protocol to communicate information over the network. Other protocols can also be used to communicate information over a network in accordance with embodiments of the present invention and any variety of techniques can be used to create separate channels for the communication of audio, video, overlay and/or command information. In other embodiments, a cellular communication protocol can be used to establish the necessary channels between the client and the server. Alternatively, the channels can be found over a connection that conforms to the IEEE 1394 standard. In other embodiments, other network protocols can be used to communicate audio, video and/or overlay and/or command information. Indeed, different networks can be used to communicate different types of information and/or different sequences of the same type of information. Although many embodiments of the invention include separate channels, several embodiments combine audio, video, overlay and/or control information on a single channel.

The audio, video and overlay information sent by the server to the client via the audio, video and overlay channels determines the information that can be presented to a user by the client. As indicated above, this information can take a variety of forms. For example, the audio, video and overlay information can be associated with a sound recording or a feature presentation. In addition, the audio, video and/or overlay information can be associated with a user interface. In many instances, the audio, video and/or overlay information may not relate to the same content. Examples include overlays containing information about other available programming that are displayed over a feature presentation or symbol overlays that inform the user that a feature presentation is fast forwarding, pausing or being manipulated in some other fashion.

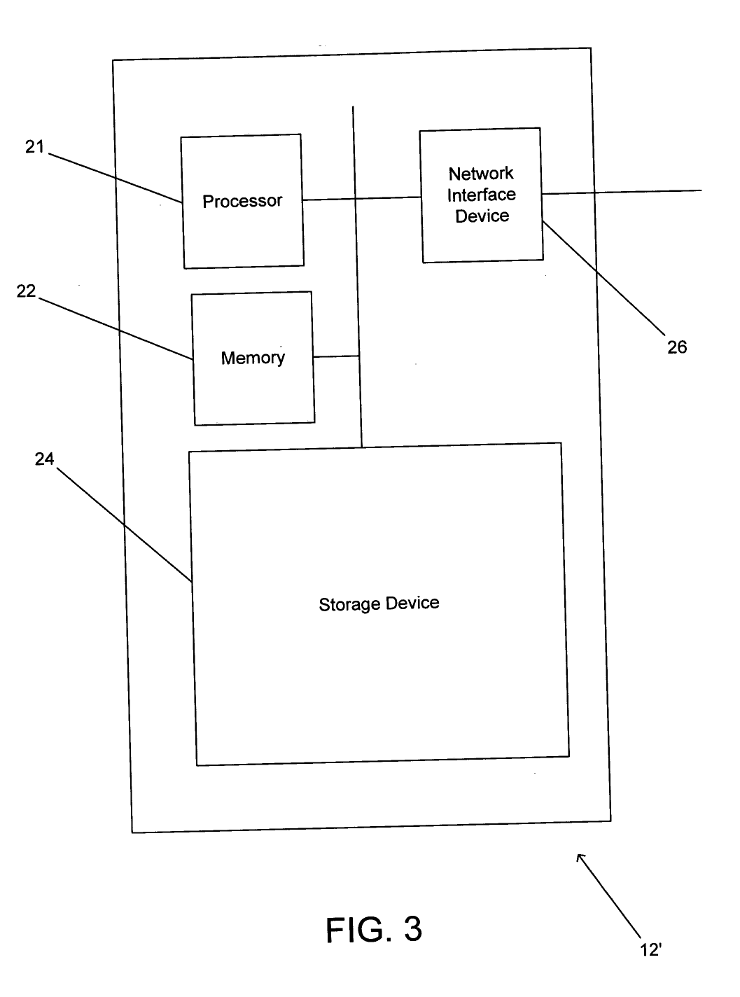

Having generally discussed the characteristics typical of embodiments of the system of the present invention, a closer examination of individual components of these systems is warranted. A server in accordance with an embodiment of the present invention is shown in FIG. 3. The server 12′ includes at least one processor 21, memory 22, a storage device 24 such as one or more hard disk drives and a network interface device 26. The processor 21 can be configured via software to provide audio, video and/or overlay information and control commands to the client via the network interface.

The storage device 24 can contain one or more data files. The data files may include one or more audio tracks, one or more pictures, one or more feature presentations and audio, video and/or overlays associated with one or more user interfaces. In one embodiment of the present invention, a stored data file can include more than one video track, more than one audio track, more than one overlay track and multimedia associated with a graphical user interface. In many embodiments of the present invention, the storage device 24 can include multimedia files similar to the multimedia files described in U.S. application Ser. No. 11/016,184 entitled “Multimedia Distribution System” to Van Zoest et al. filed on Dec. 17, 2004, the disclosure of which is incorporated herein by reference in its entirety.

In embodiments of the present invention that communicate in accordance with the TCP/IP protocol, the network interface device 26 and/or the processor 21 implement a TCP/IP protocol stack. The TCP/IP protocol stack handles the transmission of information to and from the server on each of the appropriate channels. In other embodiments the network interface device can be implemented to support other protocols.

As an aside, one of ordinary skill in the art would appreciate that the server shown in FIG. 3 is illustrated in a schematic fashion. An actual implementation of a server in accordance with an embodiment of the present invention could take any of a variety of forms. As such one of ordinary skill in the art would appreciate that any server, computer or other electronic device capable of storing multimedia files and communicating over a network with a client in the manner described herein can be used to implement an embodiment of a data distribution system in accordance with the present invention.

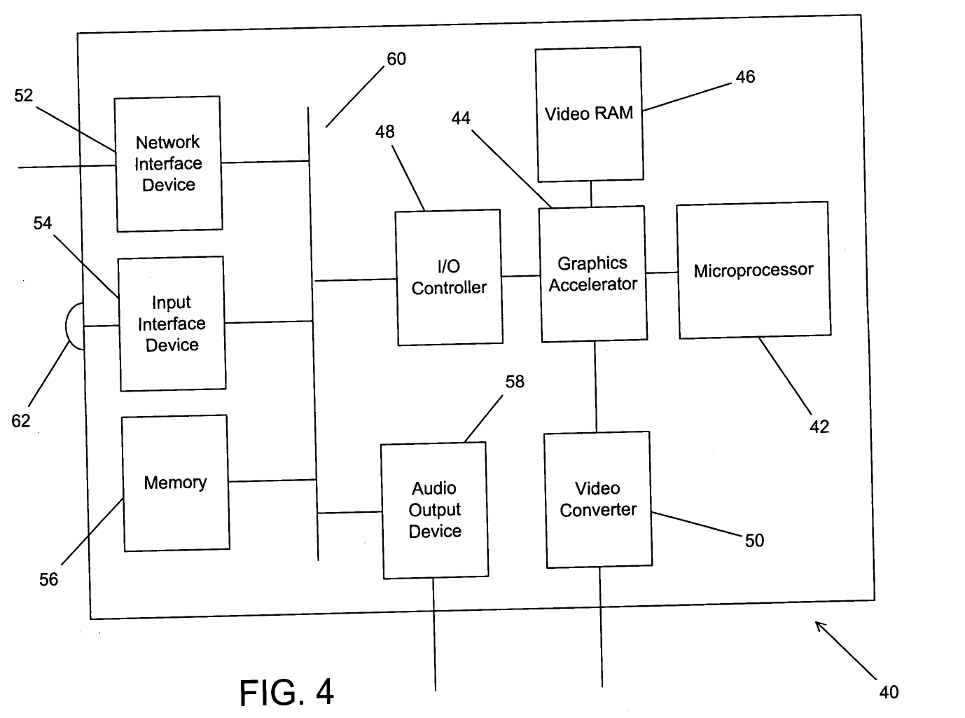

A client in accordance with an embodiment of the present invention is illustrated in FIG. 4. In the illustrated embodiment, the client 40 is a networked consumer electronics device. The client is designed to interface with the network 14 and at least one rendering device such as a television and/or a video display/monitor and/or a stereo and/or speaker. The client 40 includes a microprocessor 42. The microprocessor is configured to control the operation of the client and is connected to a graphics accelerator 44.

The graphics accelerator 44 can be used to perform repetitive processing associated with generating video frames. The graphics accelerator can also act as a hub connecting the microprocessor to video RAM 46, an I/O controller 48 and a video converter 50. The video RAM 46 can be utilized by the graphics accelerator to store information associated with the generation of video frames. The video frames can be provided to a video converter 50, which can convert the digital information into an appropriate video format for rendering by a rendering device, such as a television or video display/monitor. The format could be an analog format or a digital format. The I/O controller also interfaces with the graphics accelerator and enables the microprocessor and graphics accelerator to address devices including a network interface device 52, an input interface device 54, memory 56 and an audio output device 58 via a bus 60. The architecture shown in FIG. 4 is an architecture typical of a consumer electronics device that is an embodiment of a client in accordance with the present invention. Other architectures including architectures where the processor directly or and/or indirectly interfaces with I/O devices can also be used.

The network interface device 52 can be used to send and receive information via a network. In embodiments where information is communicated via the TCP/IP protocol the network interface device and/or other devices such as the microprocessor implement a TCP/IP protocol stack. In other embodiments, other communication protocols can be used and the network interface device is implemented accordingly.

The input interface device 54 can enable a user to provide instructions to the client 40. In the illustrated embodiment, the input interface device 54 is implemented to enable a user to provide instructions to the client 40 using an infrared (IR) remote control via an IR receiver 62. In other embodiments, other input devices such as a mouse, track ball, bar code scanner, tablet, keyboard and/or voice commands can be used to convey user input to the client 40 and the input interface device 54 is configured accordingly.

The memory 56 typically includes a number of memory devices that can provide both temporary or permanent storage of information. In one embodiment, the memory is implemented as a combination of EEPROM and SRAM. In other embodiments, a single memory component or any variety of volatile and/or non-volatile memory components can be used to implement the memory.

The audio output device 58 can be used to convert digital audio information into a signal capable of producing sound on a rendering device, such as a speaker or sound system. In one embodiment, the audio output device 58 outputs stereo audio in an analog format. In other embodiments, the audio output device can output audio information in any of a variety of analog and/or digital audio formats. In one embodiment, the MP3 audio format specified by the Motion Picture Experts Group (MPEG) is used. In other embodiments, other formats such as the AC3 format specified by the Advanced Television Systems Committee, the AAC format specified by MPEG or the WMA format specified by Microsoft Corporation of Redmond, Wash. can be used.

As will readily be appreciated by one of ordinary skill in the art, any number of configurations can be used to implement a client in accordance with embodiments of the present invention. Clients in accordance with embodiments of the present invention need not include graphics capability or audio capability. In addition, clients in accordance with aspects of many embodiments of the present invention need not accept any user input. For example, user input can be provided directly to the server or to a second client that forwards the user instructions to the necessary server or servers. Alternatively, the client may simply be unable to process or forward user instructions. Embodiments of clients in accordance with the present invention can include any variety of processing components or a single processing component. Indeed any networked consumer electronics or computing device capable of communicating with a server in the manner described herein can be used to implement a client in accordance with aspects of numerous embodiments of the present invention.

As discussed above, servers in accordance with embodiments of the present invention are capable of providing audio, video and/or overlay information to clients. A client typically initiates the transmission of information by one or more servers. Each transmission can be referred to as a control session and a client can initiate a control session by forming a connection with the control port of a server. The client then requests the initiation of a control session and if the control session is granted, the server establishes channels for audio, video and/or overlay data by sending channel assignment information to the client. Once the audio, video and/or overlay channels are established, the server can commence the transmission of audio, video and/or overlay information to the client. As was also discussed, interactivity can be achieved by the client forwarding user instructions to the server and the server responding by providing appropriate audio, video, overlay and/or control information to the client. The establishment of a control session, transmission of audio, video and/or overlay information and implementation of interactive features are now considered in more detail.

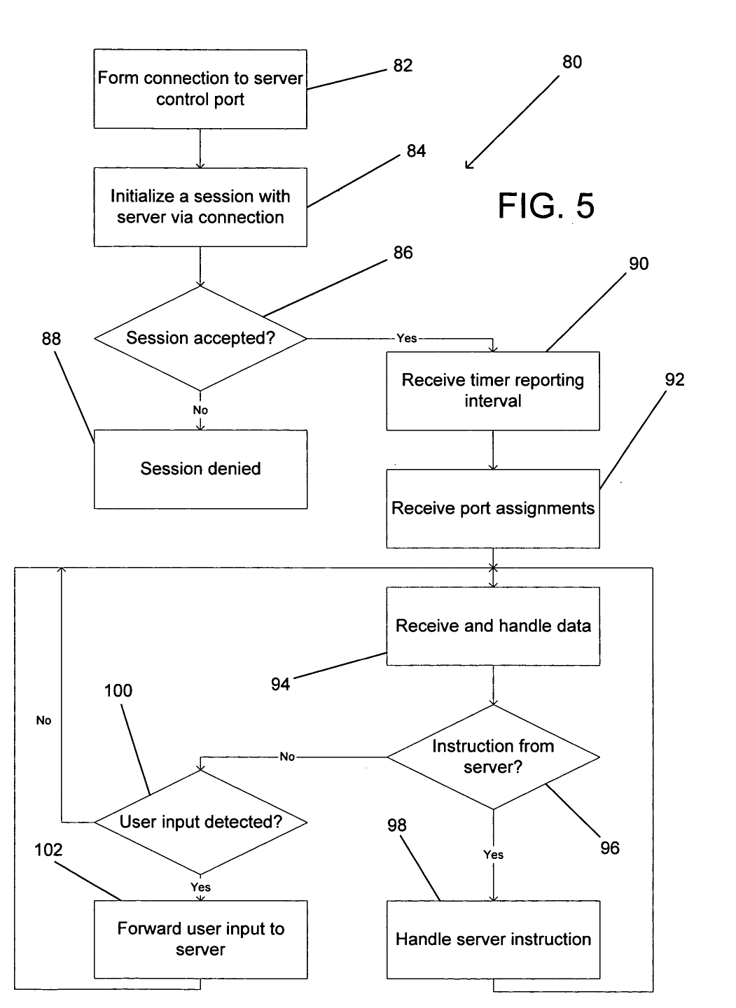

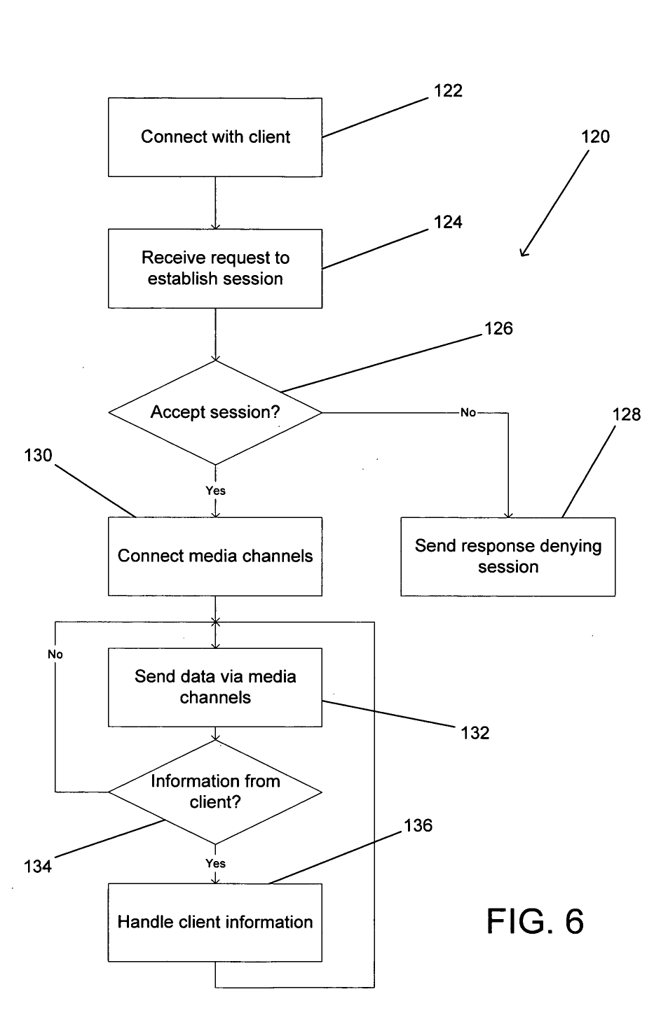

FIGS. 5 and 6 are flow charts showing the operation of a client and a server in accordance with the present invention during the establishment and conduct of a session. Turning first to FIG. 5, a flow chart showing the operation of a client in accordance with an embodiment of the present invention when establishing and conducting a control session with a server is illustrated. In the illustrated process, the TCP/IP protocol is used by the client to communicate with the server. In other embodiments, other communication protocols can be used. The process 80 commences with the client forming (82) a connection with the control port of a server. In one embodiment, a procedure based upon a protocol such as the Session Description Protocol proposed standard RFC 2327 specified by the Internet Engineering Task Force can be used to identify servers and their control ports. In other embodiments, other techniques can be used to identify the control ports of servers connected to a client via a network.

Once a control channel has been established, the client attempts to initiate (84) a control session with the server via the control channel. The attempt can be made by sending a packet requesting a control session that also contains information concerning the client's available port assignments. The client then waits (86) for the server's response to the request. In one embodiment, the server responds even if a session is denied. In other embodiments the request is assumed to be denied after a predetermined period of time has expired. If the session is denied (88), then the attempt to establish a session has failed. If the attempt is successful, the client typically receives (90) information from the server specifying the frequency with which the client should provide the server with information concerning the time stamp of the packet that the client has most recently processed and output for rendering. The importance of the client reporting packet time stamps is discussed in greater detail below.

The client also receives (92) port assignments from the server. The port assignments typically include information concerning the parameters of the audio, video or overlays provided on each channel (e.g., audio sample rate or video resolution) and the amount of audio, video or overlay information to buffer. The initialization of the channels also includes an initial time stamp for the information that will be sent on the channel. This time stamp can be used to set the client's internal timer. The client's timer typically is paused until the specified amount of data has been queued and the client commences rendering the queued data.

The initialization can include information concerning how the information arriving on a channel should be handled. In one embodiment, a client can be initialized to render incoming data when the client's timer is greater than or equal to a time stamp associated with the data. In several embodiments, a client can be initialized to render incoming data when the client's timer exactly matches a time stamp associated with the data. In these embodiments, pausing the client's timer can also pause the rendering of data from the channel. Many embodiments enable a client to be initialized to render incoming data as soon as possible after it is received by the client. In many embodiments, the client can be instructed to synchronize audio to video packets. Synchronization of audio to video can enable a client to generate sound effects accompanying transitions or actions in a user interface.

In addition to reducing the processing required of the client, providing the ability for a server to manage a client's queues enables the server to configure the client's queues in anticipation of audio, video and/or overlay information that the server is about to send to the client. If the audio, video and/or overlay information being sent by the server is part of a menu for instance, then the server can configure the client's queues so that the client is in a constant ready start state. The term “constant ready start state” describes a state where the client does not queue any information or queues very little information so that information received from the server is processed almost immediately and rendered. Alternatively, when the server is about to send audio, video and/or overlay information associated with a feature presentation then the server can configure the client to queue sufficient information to increase the likelihood that the audio, video and/or overlay will play smoothly. So-called smooth play refers to the display of frames at appropriately spaced time intervals with synchronized audio and overlays. Smooth play typically requires that the information required for rendering be available to the client when it is required. Increasing the length of the client's queues can accommodate variations in network delays that might otherwise cause packets to arrive after they are required by the client. If audio, video and/or overlay information is not available for rendering, then the user can experience a freeze in the image, an interruption to an audio track or an overlay that is not synchronized with the accompanying video or audio.

In many embodiments, the server can constantly monitor and vary the amount of information queued by the client in order to achieve predetermined quality of service parameters. In several embodiments, time stamp reports are used by the server to monitor system latency and manage the client's queues accordingly. In other embodiments, other information obtained from the client or another source can be used to monitor the quality of service provided by the system.

Following the port assignments, the client starts receiving (94) data on the audio, video and/or overlay channels from the server. The client handles the packets and performs the necessary reporting of time stamps to the server. The client can also receive (96) control instructions from the server. If a control instruction is received, the client responds (98) by handling the instruction.

The client can also receive (100) a user instruction. When the client receives a user instruction, the client typically forwards (102) the user instruction to the server. The client continues to display the multimedia information provided by the server until the control session is terminated.

In many embodiments, the client is only capable of responding to a very limited set of user instructions. For example, a client may be able to respond to volume control and power on/off instructions. If an instruction is received that relates to the rendered audio, video and/or overlays, then the client will typically respond by forwarding the instruction to the server.

In one embodiment, the client forwards all user instructions that are directed toward interrupting or altering the way in which audio, video and/or overlay information is provided to the rendering device(s). In further embodiments, the client forwards all user instructions related to the navigation of a menu or user interface to the server. In additional embodiments, the client forwards all user instructions that relate to the future speed and/or direction with which audio, video and/or overlays should be rendered by the rendering device. Examples of such instructions include pause, slow advance, slow rewind, fast forward and fast rewind. In further embodiments again, the client forwards all user instructions requesting that the audio, video and/or overlays rendered by the rendering device(s) progress in a non-linear fashion. Examples of such instructions include instructions to skip between chapters or scenes in a feature presentation or to skip between tracks or randomly play tracks of a sound recording.

In another embodiment, the client only handles user instructions that are independent of the audio, video and/or overlay being rendered by the rendering device(s) at the time the user instruction is received. An instruction is typically considered to be dependent upon the audio, video and/or overlay being rendered if the instruction in any way influences the content, speed or direction of audio, video and/or overlays rendered in the future. Examples of independent instructions include power on/off, volume control, mute, brightness control and contrast control.

Turning now to FIG. 6, a flow chart illustrating the operation of a server in accordance with an embodiment of the present invention during the establishment and conduct of a control session with a client is shown. As with FIG. 5, the illustrated process assumes that the server and client are communicating using the TCP/IP protocol. In other embodiments, other communications protocols can be used. The process 120 commences by establishing a connection with a client. As discussed above, a connection can be established (122) by a client sending a request to the server's control port. Once a connection has been established, the server receives (124) a request to establish a control session from the client via the connection. The server decides (126) whether to accept the control session. In one embodiment, the server denies a session by sending (128) a message to the client denying the session. Examples of reasons why a server could deny a control session include a server denying a control session if the content of the server is inappropriate for a particular client (e.g. the client is accessible by children and the server contains adult content). As another example, a server can also deny a session when the server is overloaded. A further example can occur when access to a server is on a pay basis and the client is not associated with a valid payment.

If the session is accepted by the server, the server establishes (130) connections for each of the data channels. In one embodiment, the data channels include an audio channel, a video channel and an overlay channel and the server designates a port assignment for each channel. In other embodiments, the data channels can include an audio and control channel, a video and control channel or a video, an overlay and a control channel or any other combination of such channels.

In embodiments where a variety of channel configurations are supported, the establishment of the data channels can include initialization of the data channels by sending information to the client specifying the format of the data. This information can include time stamp information, information concerning the amount of data to queue and the time at which data should be processed. The initial time stamp can be determined at random. The time stamp associated with data sent on the channel can be determined in accordance with the formula:
data timestamp=initial timestamp+Abs(Data start time−Data position)/Rate

where:

data timestamp is the timestamp associated with the data;

initial timestamp is the initial timestamp chosen by the server;

data start time is a predetermined time indicative of starting time that is associated with the start of a stored sequence of data;

data position is a predetermined time associated with a particular piece or collection of data that is indicative of the time at which the data would be rendered if the sequence of data were rendered linearly from its start at a predetermined rate; and

rate is a value indicative of the speed at which the server desires the data to be rendered relative to the predetermined rate.

In instances where the sequence is played faster or slower, the rate value scales the timestamp to accommodate for an increased or reduced number of frames.

Following the establishment of the data channels, the server can commence (132) sending media to the client. In one embodiment, the server extracts the media information from a file similar to the files described in U.S. patent application Ser. No. 11/016,184 to Van Zoest. In several embodiments, the server initially extracts audio, video and/or overlay information to create a user interface. Embodiments of user interfaces in accordance with the present invention can be audio interfaces, a purely graphical interface or interfaces that combine both audio and graphical components. In instances where the server uses the data channels to transmit a feature presentation, the server can select a video and audio track from a number of video and audio tracks contained within a file stored on the server. In addition, the server can select an overlay track to provide subtitles or another form of overlay such as an information bar or an icon indicating actions such as the feature presentation being paused, fast forwarded, rewound or skipped between chapters. In other embodiments, the server may only provide the audio, video or overlay track. In such embodiments, other tracks can be provided by other servers or there may not be any other data tracks.

If information is received (134) from the client, then the server responds (136) to the information. The information will typically contain a user instruction or a time stamp report. Most forwarded user instructions relate to audio, video and/or overlay information that the user wishes to access. The server's response may vary depending upon whether the information displayed at the time the user instruction was received was part of a user interface or part of a feature presentation. The handling of forwarded user instructions by an embodiment of a server in accordance with the present invention is discussed further below. However, it is worth noting that the server is able to obtain information from the time stamp reports concerning the audio, video and/or overlays at the time a user instruction was received.

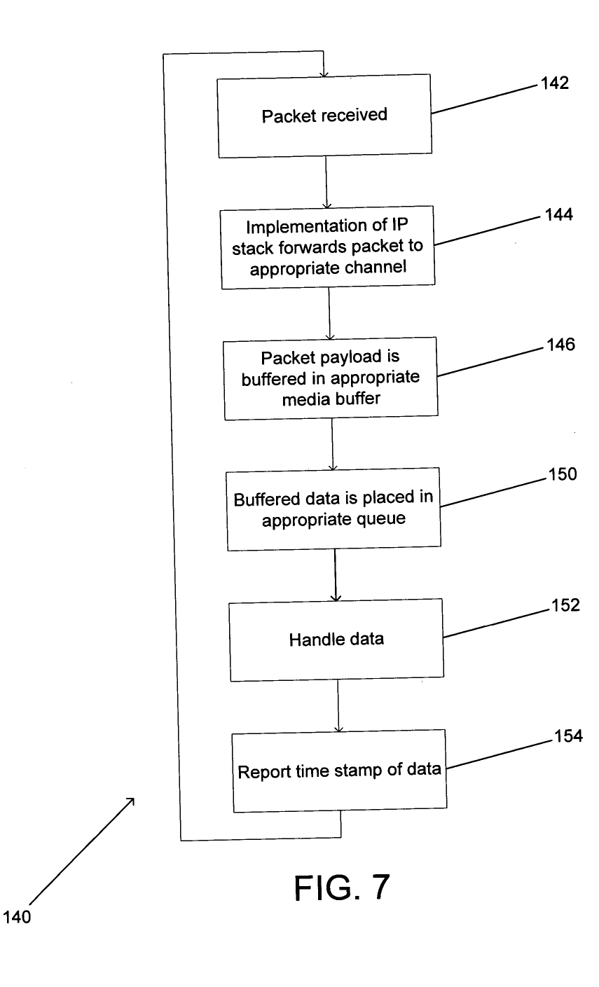

The above discussion of information exchange between an embodiment of a server and a client in accordance with the present invention. A flow chart illustrating the manner in which the client handles packets received from a server in accordance with an embodiment of the present invention is illustrated in FIG. 7. The process 140 commences with the reception (142) of a packet of information by the client. In embodiments where the server and client communicate in accordance with the TCP/IP protocol, the client's implementation of the TCP/IP stack identifies (144) the nature of the information by reference to the port address of the packet. The packet is then buffered (146) in an appropriate audio, video, overlay or control buffer. The audio, video, overlay or control information is then placed (150) in the queue appropriate to the type of the received information. The queued information is then processed (152) in an order determined by the time stamp associated with the information in the manner directed by the server (see discussion above). The time stamp of the processed information can be reported (154) to the server. Unless directed otherwise, the client continuously handles incoming packets in a similar manner.

The fact that the audio, video and/or overlay information is communicated via separate channels enables the client to access a particular type of information as soon as it arrives. In embodiments where all of the data types are multiplexed on a single channel, then the client could be forced to process the data in the order of arrival as opposed to on the basis of the data most needed by the client. Conceivably, such a client could be starved of one type of data, have a packet of that type of data stored in its buffer but be forced to process other types of data because they arrived first. However, the client could be configured to locate and handle desired information.

In many embodiments, the server can include digital rights management (DRM) information with the information transmitted on each of the audio, video, overlay and/or control channels. In one embodiment, information about the nature of the DRM information is communicated to the client by the server. The client can acknowledge that it has the ability to perform the necessary decryption to play the DRM protected information or can respond that it does not possess this ability.

As discussed previously, many embodiments of clients in accordance with the present invention do not directly respond to user instructions. Instead, the client forwards the instruction to the server and the server responds to the instruction by selecting audio, video and/or overlay information to be displayed by the client. For many embodiments, the fact that the client's capabilities do not extend far beyond the handling of incoming packets is key to the simplicity with which a client can be implemented. The handling of user instructions by embodiments of servers and client in accordance with the present invention is now considered in more detail.

Embodiments of the system of the present invention are often configured to reduce latency when responding to user instructions, because reducing latency can enhance a user's experience when interacting with the system 10. Latency is the delay between the time a user instruction is received and the display of audio, video and/or overlay information on a rendering device. There are a number of ways that embodiments of servers in accordance with the present invention can attempt to reduce latency. One technique is to manage the client's queues so that information sent in response to a user instruction is immediately processed. Were a server to respond to a user instruction by simply transmitting information to a client, delays could occur due to the client playing previously queued information before playing the newly transmitted information. The server can reduce system latency by sending an instruction to the client to flush its queues prior to the server sending the audio, video and/or overlay information in response to the user instruction. Once the queues are flushed, the newly received information can be immediately displayed by the client.

In many embodiments, the new audio, video and/or overlay information sent by a server in response to a user instruction has a different format to the previous multimedia transmission. The format changes can include changes in the encoding format of the data such as the resolution, width and height of video or sampling rate of audio, changes in the amount of data that the client should queue, changes in the manner in which the client should process data based on the data's time stamp or activation of DRM. In instances where a format change is required to respond to a user instruction, the server can reinitialize the media channels with the client prior to sending media information in the new formats.

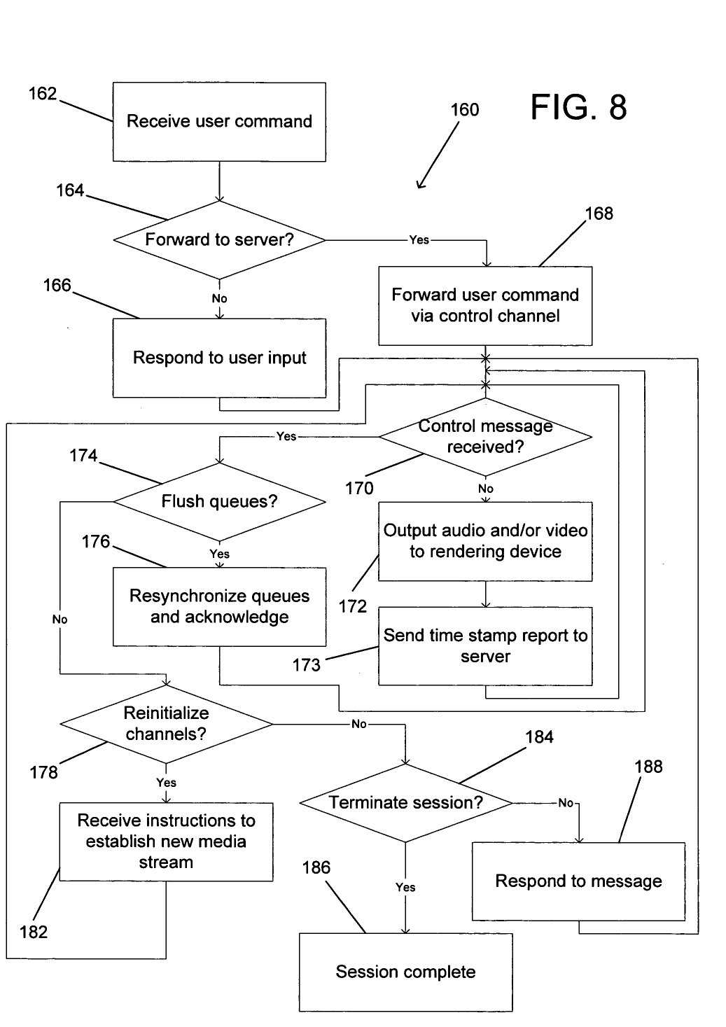

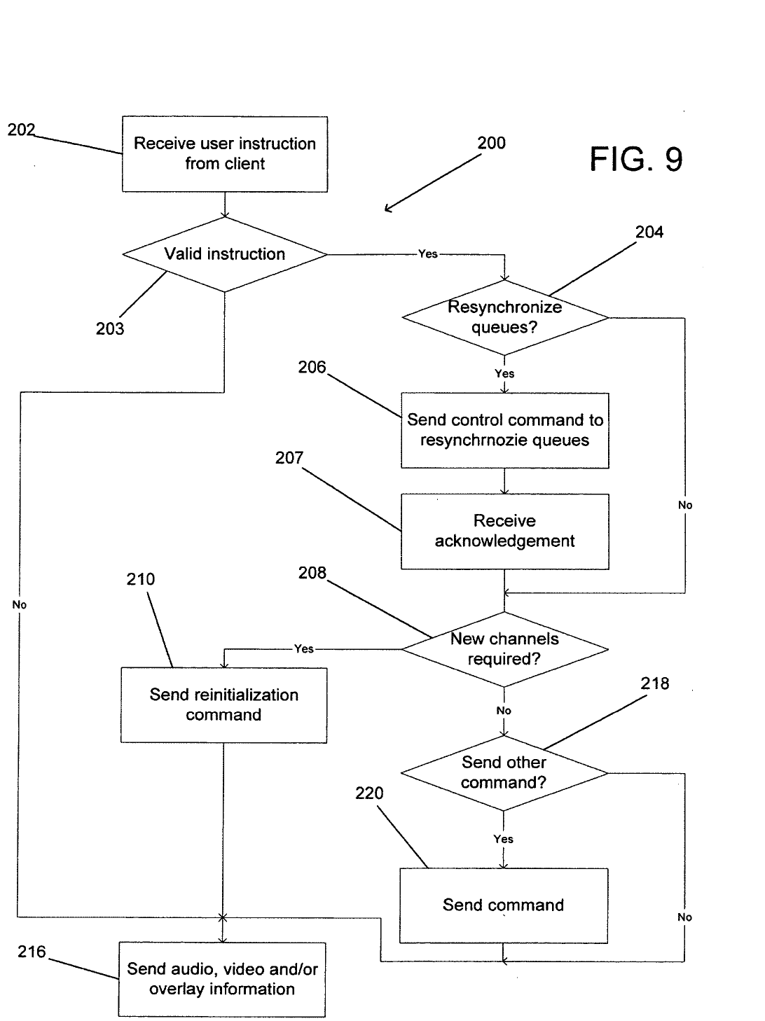

FIGS. 8 and 9 are flow charts showing the actions performed by a client and a server in accordance with one embodiment of the system of the present invention in response to the receipt of a user instruction by the client. As can be seen, the illustrated embodiments possess the ability to perform operations that reduce system latency and the ability to accommodate format changes associated with the transmission of different types of data.

Turning first to FIG. 8, a flow chart of the operation of a client in response to a user instruction and information received from a server in accordance with an embodiment of the present invention is illustrated. Before continuing, we note that the process can be interrupted by the occurrence of additional user instructions. The process 160 commences when a user command is received (162). The client inspects (164) the user command to determine whether the command can be handled by the client (typically this is an instruction that is independent of the content of the audio, video and/or overlay to be displayed following the instruction) or whether it should be forwarded to the server. If the user instruction can be handled by the client, then the client responds (166) to the user instruction and then re-enters a loop that involves checking for server commands and processing incoming audio, video and/or overlay information while awaiting interruption by further user commands.

When the user instruction cannot be handled by the client, then the user instruction is forwarded (168) to the server via the control channel. The client then enters a loop checking (170) for control messages from the server, and in the absence of a control message, processing (172) audio, video and/or overlay information for rendering and sending (173) time stamp reports via the control channel to the server at intervals specified by the server. As will be discussed further below, the time stamp reports can be used by the server to determine the audio, video and/or overlay information that was being rendered at the time a user provided an instruction.

If a control instruction is received from the server, then the client determines (174) the type of control instruction. The control instruction may command the client to resynchronize its queues. Resynchronization (176) can involve flushing queues and/or assigning a new timer value to the client. Flushing queues enables a client to immediately render new data sent by the server. In many instances, the client is resynchronized without flushing its queues. Resynchronization without flushing a queue can be useful in instances where display of information in the queue is desired, such as when the system is paused.

Following receipt of the resynchronization instruction, the client can send a resynchronization acknowledgment to the server via the control channel. The client can then continue to process audio, video and/or overlay information that it receives from the server while checking for further control instructions (170 and 172) and sending (173) time stamp reports to the server via the control channel.

The client may determine (178) that the control requires reinitialization of the data channels. Once the client has adapted (182) to the new channel parameters provided by the server, the client continues to process and output audio, video and/or overlay information for display by a rendering device while checking for further control instructions (170 and 172) and sending (173) time stamp reports to the server via the control channel.

The client may determine (184) that the control instruction requires the termination of the control session. In which case, the client terminates (186) the control session by disconnecting each of the audio, video, overlay and/or control channels that have been established. The client can also handle (188) other types of control instructions necessary to implement the functionality of the system. Following the handling of a control instruction, the client typically continues to process audio, video and/or overlay information for display by a rendering device while checking for further control instructions (170 and 172) and sending (173) time stamp reports to the server via the control channel.

Turning now to FIG. 9, a flow chart of the operation of a server in accordance with an embodiment of the present invention upon receiving a forwarded user instruction from a client is illustrated. The process 200 commences with the receipt (202) of a user instruction that has been forwarded by a client on the control channel. The server determines (203) the nature of the user instruction and responds accordingly. The appropriate response to a user instruction typically depends upon the content of the audio, video and/or overlay information being displayed by the rendering device at the time the user instruction is received. In many embodiments, the client's time stamp reports enable the server to precisely determine the audio, video and/or overlay information being rendered at the time a user instruction is received. A user may have provided an instruction that is inappropriate in the context of the audio, video and/or overlay information being rendered at the time the user issued the instruction. For example, a direction to rewind when a menu is being displayed can be inappropriate as can an instruction to select a menu option during the rendering of a feature presentation.

During a feature presentation, valid user instructions typically require the manipulation of the speed and/or direction in which the feature is being presented, the transition to a menu and/or the addition of an overlay. When a menu is being rendered, the server typically possesses information concerning the valid actions that can be performed during the display of a particular menu. This information can take the form of a state machine. If the server has a record of the menu state at the time the user issues an instruction, then a valid instruction will typically involve a transition to another menu state or the display of a feature presentation.

When the user instruction requires the immediate display of audio, video and/or overlay information by the client, then the server can send (206) a control instruction directing the client to flush any queued media information, if determined (204) to be appropriate. Once the resynchronization message has been sent and acknowledged (207), the server can send the required audio, video and/or overlay information. As discussed above, flushing the queues can reduce the latency with which the system responds to user instructions and avoid awkward jumps in feature presentations as information queued by the client prior to the instruction is rendered. Other types of resynchronization of the server and the client can also be performed.

When a feature presentation is being rendered, the server can use time stamp reports provided by the client to determine the audio, video and/or overlay information that was being rendered at the time the user instruction was received. The server can then respond to a user instruction involving the speed and direction in which the feature is presented by flushing the queue and sending audio, video and/or overlay information that, when processed by the client and rendered, presents the feature in accordance with the user's instructions concerning speed and direction from the point in the rendered feature presentation corresponding to the point at which the user instruction was issued. By flushing the queues, the server is often forced to resend information that was being queued by the client prior to the user issuing an instruction. However, the queued information would have been rendered by the client in a way that would not have conformed with the user's instructions, detracting from the user's experience of the system.

When the server determines (208) that the user instruction requires the transmission of a different type of multimedia information to the multimedia information sent previously, then the server can send (210) a control instruction to the client directing the client to reinitialize the audio, video and/or overlay channels. The server then commences transmitting (216) audio, video and/or overlay information in accordance with the new channel parameters.

The above description is not meant to be exhaustive of the control instructions that can be sent by a server in response to a user instruction or under any other circumstance for that matter. If the server determines (218) that another type of command should be sent (220) to the client, then the server can send (220) such a command. Indeed, the server may determine that no command is required to be sent to the client and simply send multimedia information in accordance with the user instruction.

The above description has generally focused upon instances where audio, video and/or overlay information are provided by a single server. Many embodiments of the present invention use multiple servers to provide information to clients. In one embodiment, multiple servers simultaneously provide information to a client with each of the servers providing different types of information. In another embodiment, a first server provides audio, video and/or overlay information to a client and then a transition is made and a second server provides audio, video and/or overlay information to the client.

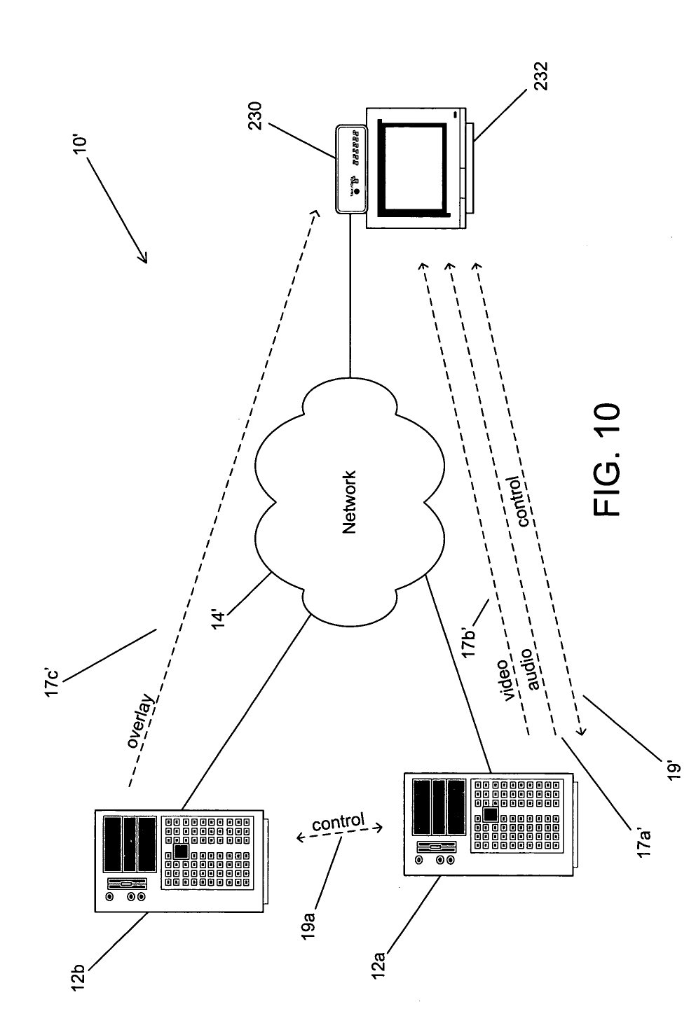

An embodiment of a system in accordance with the present invention where multiple servers are capable of simultaneously providing data to a client is illustrated in FIG. 10. The system 10′ includes multiple servers 12a, 12b connected to a client 230 via a network 14′. The client is connected to a rendering device 232 that enables the display of audio, video and/or overlay information received by the client. FIG. 10 also conceptually illustrates the channels that exist between the servers and the client. A first server 12a is connected to the client via a video 17b′ and an audio channel 17a′. The client and the first server are also able to communicate with each other via a control channel 19′. A second server 12b is connected to the client via an overlay channel 17c′ and to the first server via a two way control channel 19a. The configuration shown in FIG. 10 resembles a configuration that might exist if a feature presentation were being provided by a first server and subtitle overlays in a specific language were being provided by a second server.

When information is being sent to a client from multiple servers, coordinating the information delivered to the client can become problematic. In many embodiments, a single server is chosen to act as a control hub. The control hub server is responsible for forwarding appropriate control messages to all of the servers communicating with a client and for forwarding control messages from other servers to the client. Typically, the control hub is chosen to be the server with which a client initially seeks to establish a control session. In many instances, the user will request information that is not present on a first server and the first server will seek to establish connections with other servers that can provide the desired information. In some instances, this may simply be a single channel of information. In other instances, all of the desired information may be resident on another server. For example, a first server may store information for a user interface and the user interface enables a user to access a feature presentation that is stored on another server. In instances where a first server provides all of the required information for a period of time and then a second server provides all of the required information for a period of time, the first server can function as a control hub or hand control off to the second server.

Embodiments of systems in accordance with the present invention can also include one or more servers communicating with one or more clients. In these embodiments, a single server can act as a control hub and maintains control connections with each of the servers and clients that are present in a particular control session. Alternatively, control messages can be broadcast to all of the servers and clients involved in the control session. In one embodiment, a server or client will be part of a control session, if the server or client provides information to or is responsive to instructions from the client that first initiated the control session with one of the servers. In other embodiments, a server or client can be part of a control session if it communicates information within a particular network such as a home network or portion of a network such as a virtual private network. In many embodiments, the server that acts as the control hub determines the clients and servers that form part of the control session.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A data distribution system, comprising:
a server connected to a client via a network;
wherein the server is configured to communicate audio, video, overlay and control information with the client via separate audio, video, overlay and control channels;
wherein information transmitted on at least one of the audio, video and overlay channels includes time stamps;
wherein the client is configured to process the audio, video and overlay information for output to one or more rendering devices and to transmit information concerning time stamps of processed information to the server via the control channel.

2. The data distribution system of claim 1, wherein the client is further configured to place audio, video and overlay information into audio, video and overlay queues.

3. The data distribution system of claim 1, wherein the client is further configured to process received control information by resynchronizing with a server.

4. The data distribution system of claim 1, wherein:
the client is further configured to forward one of a set of predetermined user instructions to the server; and
the server is further configured to send information via at least one of the audio, video, overlay and control channels in response to the forwarded user instruction.

5. The data distribution system of claim 4, wherein the server is further configured to select information to send to the client in response to the forwarded user instruction based upon information maintained by the server concerning information that has been processed by the client.

6. The data distribution system of claim 5, wherein the information maintained by the server includes time stamp information received from the client.

7. The data distribution system of claim 4, wherein the information sent by the server includes an instruction sent on the control channel directing the client to reinitialize at least one of the audio, video and overlay channels.

8. The data distribution system of claim 4, wherein:
the client is further configured to process received audio, video and overlay information by placing information in one or more queues; and
the information sent by the server includes an instruction sent on the control channel that directs the client to flush at least one of the one or more queues.

9. The data distribution system of claim 8, wherein the instruction directs the client to flush all of the one or more queues.

10. The data distribution system of claim 1, wherein the server comprises:
a first server configured to communicate audio information to the client using the audio channel; and
a second server configured to communicate video information to the client using the video channel.

11. The data distribution system of claim 1, wherein the server comprises:
a first server configured to communicate audio information to the client using the audio channel; and
a second server configured to communicate overlay information to the client using the overlay channel.

12. The data distribution system of claim 1, wherein the server comprises:
a first server configured to communicate video information to the client using the video channel; and
a second server configured to communicate overlay information to the client using the overlay channel.

13. The data distribution system of claim 1, wherein the server comprises:
a first server configured to provide information to the client via at least one of the audio, video and overlay channels; and
a second server configured to provide information to the client via at least one of the audio, video and overlay channels in response to an instruction received from the first server via the control channel.

14. The data distribution system of claim 1, wherein:
the server comprises a first server and a second server;
the client is configured to receive a user instruction and forward the user instruction to the first server; and
the first server is configured to respond to the user instruction forwarded by the client by providing an instruction to the second server directing it to provide information to the client.

15. The data distribution system of claim 1, wherein:
the client is configured to process information received on the audio, video and overlay channels as soon as the information is received by the client.

16. The data distribution system of claim 1, wherein:
the client includes an internal timer set by the server;
the client is further configured to process information received on the audio, video and overlay channels for output on one or more rendering devices when a time stamp associated with the information matches the internal timer.

17. The data distribution system of claim 1, wherein:
the client includes an internal timer synchronized to the server;
the client is further configured to process information received on the audio, video and overlay channels for output on a rendering device when a time stamp associated with the information is less than or equal to the internal timer.

18. The data distribution system of claim 1, wherein:
the client is further configured to synchronize the processing of audio information received on the audio channel with video information received on the video channel.

19. A client, comprising:
a processor; and
a network interface configured to communicate with the processor and to receive packets of audio, video, overlay and control information on separate channels;
wherein the processor is configured:
to place information from the packets of audio, video and overlay information in audio, video and overlay queues;
to inspect queued audio, video and overlay information for time stamps; and
to select information in the audio, video and overlay queues for processing based upon the time stamps of the information;
wherein the processor and network interface are further configured to transmit a report containing information concerning the time stamp of at least one of the packets selected for processing.

20. The client of claim 19, further comprising:
a user interface;
wherein the processor is further configured to generate a control message for output on the network interface in response to predetermined input from the user interface.

21. The client of claim 19, wherein the network interface is further configured to forward control messages received on a control channel to the processor.

22. The client of claim 21, wherein the processor is further configured to respond to a predetermined control message by flushing the audio, video and overlay queues.

23. The client of claim 21, wherein:
the audio, video and overlay queues are initialized in a first configuration; and
the processor is further configured to reinitialize the audio, video and overlay queues to a second configuration in response to a predetermined control message.

24. A server, comprising:
a processor; and
a network interface in communication with the processor;
wherein the processor and network interface device are configured to transmit audio, video, overlay and control information including time stamps; and
wherein the network interface is further configured to receive control information.

25. The server of claim 24, wherein the processor is further configured to select audio, video and overlay information to transmit in response to the received control information.

26. The server of claim 25, wherein the processor is further configured to select control information to transmit in response to the received control information.

27. The server of claim 24, wherein the processor is further configured to store information concerning display of audio, video and overlay information by a client from a received control message.

28. The server of claim 25, wherein the processor is further configured to select audio, video and overlay information to transmit in response to the received control information based upon stored information concerning display of audio, video and overlay information by a client.

29. A method of communicating data over a data network, comprising:
transmitting audio, video, overlay and control information and time stamps associated with one or more of the audio, video, overlay and control information;
receiving the audio, video, overlay and control information and the time stamps associated with one or more of the audio, video, overlay and control information;
queuing the received information in separate audio, video and overlay queues;
processing the queued information based on the time stamps associated with the information;
transmitting a reporting indicating at least one time stamp of the processed information;
receiving the report; and
recording information concerning the at least one time stamp contained within the received report.

30. The method of claim 29, further comprising responding to received control information.

31. The method of claim 30, further comprising responding to the received control information by flushing the audio, video and overlay queues.

32. The method of claim 29, further comprising receiving a user instruction and transmitting information indicative of the user instruction.

33. The method of claim 29, wherein the processing comprises rendering audio, video and overlay information.
